(19) United States
(12) Patent Application Publication
(10) Pub. No.: US 2024/0106694 A1
(43) Pub. Date: Mar. 28, 2024

(54) AUTOMATIC INHERITANCE OF SIMILAR ALERT PROPERTIES

(71) Applicant: ServiceNow, Inc., Santa Clara, CA (US)

(72) Inventors: Darius Koohmarey, San Diego, CA (US); Mahesh Satyendra Bhandarkar, San Jose, CA (US); Christine Sterner, San Diego, CA (US)

(21) Appl. No.: 17/954,090

(22) Filed: Sep. 27, 2022

(51) Int. Cl. H04L 41/06; G06F 18/23213; H04L 41/12; H04L 41/142; H04L 41/16

(52) U.S. Cl. CPC H04L 41/06; G06F 18/23213; H04L 41/12; H04L 41/142; H04L 41/16

(57) ABSTRACT

A new alert is received. Machine learning is used to identify a plurality of resolved alerts similar to the new alert. One or more processors are used to automatically identify among properties of the identified similar resolved alerts, one or more common properties of the identified similar resolved alerts having one or more statistical metrics meeting one or more corresponding thresholds. The new alert is caused to inherit the identified one or more common properties.

### BACKGROUND OF THE INVENTION

Information technology (IT) is the use of computers to store, retrieve, transmit, and manipulate data. IT systems include information systems, communications systems, and computer systems (e.g., hardware, software, and peripheral equipment) operated by users. IT services assets/services include various applications, microcontainers, clouds, etc. IT systems oftentimes support business operations. An IT administrator, also known as a system administrator, is a specialist responsible for the maintenance, configuration, and reliable operation of IT systems, including servers, network equipment, and other IT infrastructure. IT administrators respond to IT alerts, which are notifications indicating IT assets/services are no longer functioning as expected. IT administrators and other roles (e.g., site reliability engineers, application developers, etc.) are tasked with resolving these IT alerts by remediating the underlying IT issues. Oftentimes, an IT administrator does not possess sufficient information to efficiently address IT alerts. Thus, techniques directed toward providing IT administrators with more relevant information regarding IT alerts would be beneficial.

### BRIEF DESCRIPTION OF THE DRAWINGS

Various embodiments of the invention are disclosed in the following detailed description and the accompanying drawings.

FIG. 1 is a block diagram illustrating an embodiment of a system for managing information technology (IT) alerts.

FIG. 2 is a flow diagram illustrating an embodiment of a process for causing inheritance of alert properties.

FIG. 3 is a flow diagram illustrating an embodiment of a process for identifying similar alerts.

FIG. 4 is a flow diagram illustrating an embodiment of a process for identifying common properties of similar alerts.

FIG. 5 is a flow diagram illustrating an embodiment of a process for taking an action based on an inherited alert property.

FIG. 6 is a functional diagram illustrating a programmed computer system.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications, and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Automatic inheritance of similar alert properties is disclosed. A new alert is received. Machine learning is used to identify a plurality of resolved alerts similar to the new alert. One or more processors are used to automatically identify among properties of the identified similar resolved alerts, one or more common properties of the identified similar resolved alerts having one or more statistical metrics meeting one or more corresponding thresholds. The new alert is caused to inherit the identified one or more common properties.

In various embodiments, an alert is associated with a metric that has reached a specified threshold. As used herein, an alert refers to an automatically generated notification informing a specialist (e.g., an IT administrator) that a specified IT asset and/or service for which the specialist is responsible is no longer functioning as expected. Alerts oftentimes correspond to a specific set of fields, which can be considered metadata for the alerts. In many scenarios, alerts need to be categorized and triaged, e.g., by the specialist. This may include examining and updating, for each alert, a priority level that corresponds to whether the alert will lead to a more serious problem (also referred to herein as an incident). Stated alternatively, some alerts turn into incidents that require specialist intervention.

The techniques disclosed herein relate to determining, for a new alert, similar prior alerts so that relevant information regarding the new alert can be provided and/or appropriate action taken with respect to the new alert. For example, in some embodiments, the percentage of similar prior alerts that turned into incidents that required specialist intervention is determined to decide whether the new alert should be preemptively addressed by a specialist/technician before the new alert become an incident. Prior approaches to the problems addressed by the techniques disclosed herein are deficient because they surface similar prior alerts without presenting additional guidance. The additional post-processing and data enrichment for new alerts associated with the techniques disclosed herein provide the technological benefit of improving IT system performance by addressing IT system incidents before they occur. In various embodiments, by enriching alerts with relevant metadata, the time required to route alerts to appropriate technicians and on-call service is reduced and context that can be used to aide in the diagnosis and remediation of IT issues is provided.

The techniques disclosed herein allow for alerts to drive actions. For example, a new alert may have its priority level set and/or be assigned an incident probability. If the priority level is greater than a specified threshold or the incident probability is greater than another specified threshold, then an action may be taken. Another example is inheriting context such as categorization or tagging of an alert with specific labels that will aid in future reporting or search. An example of an action is a notification to an IT specialist to actively remediate the new alert. The priority level and/or the incident probability can also affect the level of notification (e.g., notification that immediate action is required, notification that next-day response is appropriate, etc.), the person or team that is notified (e.g., a specified technician with a specified area of expertise), additional people that are notified (e.g., adding a specific person as an IT responder), and so forth. In various embodiments, various thresholds and their corresponding triggered action responses can be set by a user. By providing enriched data such as incident probability, the time required to bring together collaborators on an incident is reduced. In terms of incident response metrics, mean time to respond, mean time to diagnose, and mean time to remediate are improved.

In various embodiments, to determine similar prior alerts, a machine learning model is utilized. In some embodiments, the machine learning model has been trained on a specific set of alert fields corresponding to different alert properties. Examples of specific alert fields include various metrics (e.g., latency, saturation, number of errors), service (e.g., a specific service product provided to end users, such as a specific software program or entertainment content item), IT resource (e.g., a specific computing component, such as a specific server rack), and so forth. In some embodiments, alerts are clustered based on their fields, which may be tokenized and/or vectorized, as part of determining similar prior alerts. Clustering (also referred to as cluster analysis) is an unsupervised machine learning task that involves automatically discovering natural groupings in data. Clustering techniques, such as density-based spatial clustering of applications with noise (DB SCAN) and K-means, interpret input data to determine natural groups (also referred to as clusters) in a feature space. A cluster is often an area of density in the feature space for which examples (e.g., prior alerts) are closer to the cluster than other clusters. In some embodiments, a center (centroid) is computed for each cluster to aid in computing closeness to the corresponding cluster.

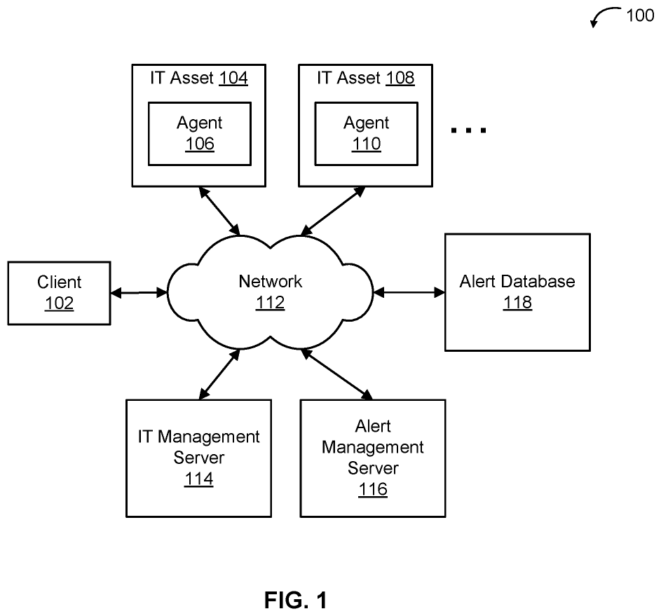

FIG. 1 is a block diagram illustrating an embodiment of a system for managing information technology (IT) alerts. In various embodiments, system 100 is utilized to cause a new alert to inherit properties of similar prior alerts that have been resolved. In the example shown, system 100 includes client 102, IT assets 104 and 108, network 112, IT management server 114, alert management server 116, and alert database 118. In some embodiments, client 102 is a programmed computer system. In various embodiments, client 102 is a computer or other hardware device that a user, such as an IT administrator, utilizes to interface with one or more servers associated with managing and remediating alerts. Examples of client hardware devices include desktop computers, laptop computers, tablets, smartphones, and other devices. In various embodiments, client 102 includes a software user interface, such as a graphical user interface, through which the user views alerts associated with IT items (e.g., problems and issues associated with the items), views alert properties, and so forth. The software user interface may be a web portal, internal network portal, other portal, browser, or mobile application that allows users to manage and remediate alerts. In various embodiments, client 102 is utilized to configure system 100 (e.g., configure IT management server 114 and alert management server 116).

In some embodiments, client 102 is a mobile device that includes a user interface that allows the user to view alerts, view potential remediations, and select remediations to initiate. In various embodiments, the mobile device is a computing device that is small enough to hold and operate in a person's hand. In various embodiments, the mobile device includes a flat screen display (e.g., a liquid crystal display or a light-emitting diode display), an input interface (e.g., with touchscreen digital buttons), and wireless connectivity hardware (e.g., Wi-Fi, Bluetooth, cellular, etc.). Examples of mobile devices include smartphones, smartwatches, and tablets.

In the example illustrated, client 102 is communicatively connected to network 112. IT alerts are managed and remediated by interfacing with IT management server 114 via network 112. Examples of network 112 include one or more of the following: a direct or indirect physical communication connection, mobile communication network, Internet, intranet, Local Area Network, Wide Area Network, Storage Area Network, and any other form of connecting two or more systems, components, or storage devices together. In the example illustrated, various IT components (e.g., IT assets 104 and 108, IT management server 114, and alert management server 116) are communicatively connected via network 112. In various embodiments, each IT component is a computer or other hardware component (e.g., a server) that provides a specified functionality for client 102 or another computer or device.

In the example illustrated, IT assets 104 and 108 are examples of IT assets from which IT problems may arise. These IT problems cause IT alerts to be generated. For example, software applications or software processes running on IT assets 104 and 108 may be unresponsive, thus triggering alerts. As another example, hardware components of IT assets 104 and 108 may also become unresponsive or otherwise fail to perform properly, thus triggering IT alerts. Examples of hardware IT problems include power supply problems, hard drive failures, overheating, connection cable failures, and network connectivity problems. Problems may also arise with technical business applications that teams are responsible for, such as authentication, a payment processing system, a web application for employees and/or customers, etc. Anytime these services are degraded and not performing to agreed user expectations in dimensions such as latency, errors, etc. can trigger alerts. The example shown in FIG. 1 is illustrative and not restrictive. Additional IT assets may also exist and be communicatively connected via network 112.

In the example illustrated, IT assets 104 and 108 include agents 106 and 110, respectively. Agents 106 and 110 are software applications (e.g., event monitoring software) that collect, analyze, and report specified event occurrences on IT assets 104 and 108, respectively. In some embodiments, each agent detects IT performance problems, collects associated information, and transmits the information to alert management server 116. In various embodiments, alert management server 116 utilizes the information transmitted by an agent to create an alert associated with an IT problem. In various embodiments, the alert includes various fields that are useful for uniquely identifying the alert and managing the alert. Examples of alert fields include a number field (e.g., storing a unique identification number), a source field (e.g., storing the event monitoring software reporting the problem), a node field (e.g., storing a domain name, IP address, MAC address, etc. associated with the IT problem), an alert text description (also referred to as alert description text) field (e.g., storing a text description of the IT problem), a configuration item field (e.g., storing a JavaScript Object Notation (JSON) string that identifies the service component, infrastructure element, or other IT item—hardware, software, network, storage, or otherwise—that is managed to ensure delivery of IT services), a severity field (e.g., storing a qualitative rating of the severity of the alert, such as critical, major, minor, etc.), a priority level field (e.g., similar to the severity field but instead storing a quantitative rating, such as 1, 2, or 3, of the severity of the alert), a state field (e.g., storing a status, such as open, closed, etc.), an acknowledged field (e.g., storing an indication as to whether a user has acknowledged the alert), an initial event generation time field (e.g., storing the time when an agent detected the underlying event/IT problem that triggered the alert), an alert creation field (e.g., storing the time when the alert was created), etc.

In some embodiments, alert management server 116 is accessed by IT management server 114. In some embodiments, IT management server 114 provides various IT management services and tools that are controlled by client 102 via network 112 to manage IT items (e.g., IT problems/issues associated with IT assets 104 and 108). Examples of IT management tasks include creating and updating an inventory of IT assets, defining and managing user access priorities associated with various IT assets, configuring and running IT infrastructure components, and managing IT alerts. Thus, in addition to accessing alert management server 116, IT management server 114 may also access various other IT related services hosted on different servers. In various embodiments, IT management server 114 provides an alert remediation interface to a user through client 102. In various embodiments, IT management server 114 implements the techniques disclosed herein. For example, IT management server 114 can coordinate with alert management server 116 and alert database 118 to determine similar prior alerts to a new alert, cause fields of the new alert to be updated based on properties of the determined similar prior alerts, and initiate actions (e.g., emailing or otherwise notifying technicians with instructions to attend to the new alert) depending on the updated properties of the new alert. In some embodiments, IT management server 114 receives an alert of interest from alert management server 116 for evaluation.

IT management server 114 determines similar alerts by comparing a given alert of interest against alerts stored in alert database 118. Alert database 118 is an example of an alert data store (a storage location for alerts). In various embodiments, alert database 118 is a structured set of data held in one or more computers and/or storage devices. Examples of storage devices include hard disk drives and solid-state drives. In some embodiments, alert database 118 stores specified alert information corresponding to IT problems associated with IT assets communicatively connected to network 112 (e.g., IT assets 104 and 108). In some embodiments, alert database 118 receives information to store from alert management server 116. For example, in some embodiments, upon closure of an alert, alert management server 116 transfers specified alert data fields to alert database 118 for storage. The stored information can be used for future reference and alert management purposes. In the example illustrated, alert management server 116 and alert database 118 are shown as separate components that are communicatively connected. It is also possible for alert database 118 to be a part of alert management server 116 and for alert management server 116 to manage transfer of alert database data to IT management server 114. Alternatively, it is possible for IT management server 114, alert management server 116, and alert database 118 to be integrated as subcomponents into a unified IT instance.

In some embodiments, the techniques disclosed herein are utilized in a data center IT environment. In a data center environment (and in other IT environments), multiple alerts can be reported by multiple monitoring systems in a short period of time. Because alerts are reported rapidly, it can be difficult to analyze alerts quickly in real time to determine appropriate remediation actions. Prior approaches can be cumbersome due to the need to manually analyze alerts, which can be infeasibly time consuming for IT administrators. The techniques disclosed herein are advantageous because they can be utilized to automatically determine alert properties that drive action based on relevant prior alerts, thereby saving time for IT administrators.

In the example shown, portions of the communication path between the components are shown. Other communication paths may exist, and the example of FIG. 1 has been simplified to illustrate the example clearly. Although single instances of components have been shown to simplify the diagram, additional instances of any of the components shown in FIG. 1 may exist. For example, additional clients and IT assets may exist. The number of components and the connections shown in FIG. 1 are merely illustrative. Components not shown in FIG. 1 may also exist.

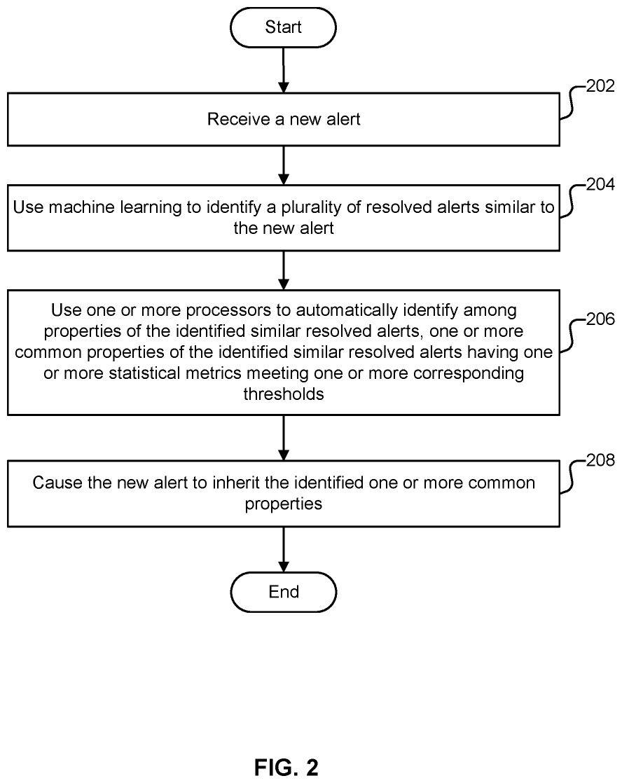

FIG. 2 is a flow diagram illustrating an embodiment of a process for causing inheritance of alert properties. In some embodiments, the process of FIG. 2 is performed by IT management server 114 of FIG. 1.

At 202, a new alert is received. In some embodiments, the new alert is received by IT management server 114 of FIG. 1 from alert management server 116 of FIG. 1. In various embodiments, the new alert is comprised of a plurality of fields. Some of the fields are utilized in comparisons with prior alerts to determine similarity with the prior alerts. Such fields can include type of service or IT resource affected, number of warnings or errors logged, computing metrics associated with latency, memory usage, central processing unit (CPU) usage, etc., metric name, metric type, priority, tags, description, node, and other data items.

At 204, machine learning is used to identify a plurality of resolved alerts similar to the new alert. In some embodiments, the plurality of resolved alerts are stored in alert database 118 of FIG. 1. In some embodiments, a clustering approach (as described in further detail herein) is utilized to identify the plurality of resolved similar alerts similar to the new alert.

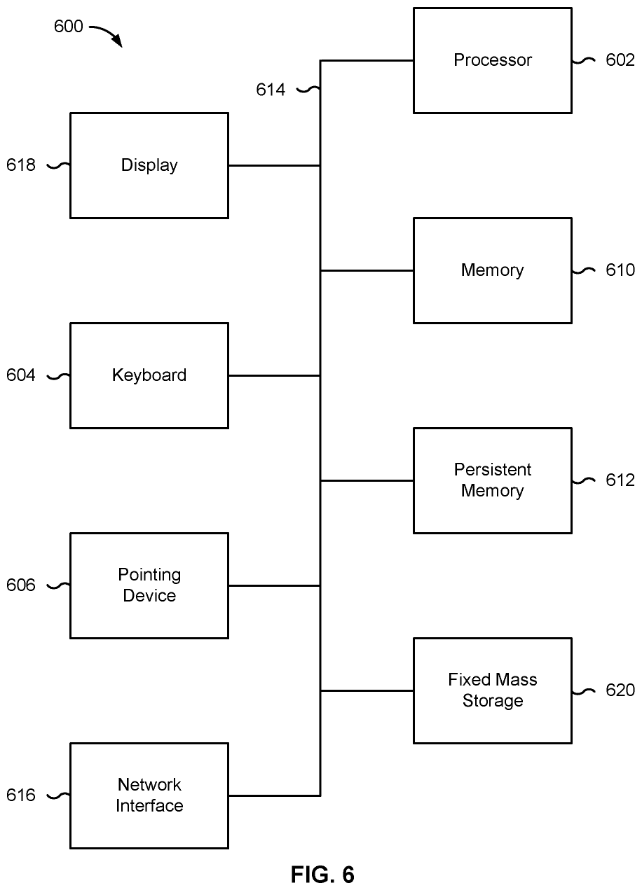

At 206, one or more processors are used to automatically identify among properties of the identified similar resolved alerts, one or more common properties of the identified similar resolved alerts having one or more statistical metrics meeting one or more corresponding thresholds. In some embodiments, at least one of the one or more processors is included in computer system 600 of FIG. 6. In various embodiments, the one or more common properties are fields such as service, resource, and computing metrics. Stated alternatively, the one or more common properties can be alert data fields. Another example of a common property is elevation of an alert to incident status or another indicator of alert severity. Elevation to incident status indicates an increase over time in information technology problem severity. In some embodiments, a statistical metric of the one or more statistical metrics is percentage of alerts of the identified similar resolved alerts sharing the common property and a threshold is a specific value that the percentage must equal or surpass. For example, elevation of an alert to an incident may be identified as a common property if a threshold percentage of alerts of the identified similar resolved alerts became incidents. Suppose that there are 100 identified similar resolved alerts. If the threshold of the percentage of alerts that must share a property before that property is identified as a common property is 60%, then, in some embodiments, elevation to incident status would be identified as a common property if at least 60 of the alerts of the 100 identified similar resolved alerts attained incident status.

At 208, the new alert is caused to inherit the identified one or more common properties. For example, if elevation to incident status is a common property (e.g., determined to be common enough within a group of identified similar prior alerts based on a percentage metric), then the new alert could inherit “incident” as a property of the new alert. In some embodiments, action is taken based on the inherited property. For example, because the new alert has inherited the incident property, action may be taken (e.g., a notification automatically sent to a technician) to preemptively address the new alert (e.g., alert remediation by addressing the underlying technical problems) before the new alert becomes an incident.

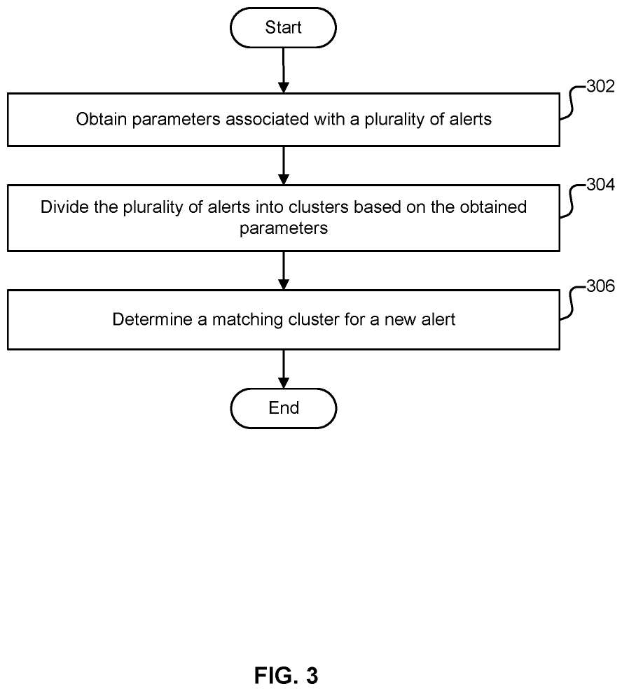

FIG. 3 is a flow diagram illustrating an embodiment of a process for identifying similar alerts. In some embodiments, the process of FIG. 3 is performed by IT management server 114 of FIG. 1. In some embodiments, at least a portion of the process of FIG. 3 is performed in 204 of FIG. 2.

At 302, parameters associated with a plurality of alerts are obtained. In some embodiments, the parameters include values of specified alert fields. The specified alert fields are typically a subset of all available alert fields. Examples of alert fields include various metrics (e.g., latency, saturation, number of errors), service (e.g., a specific service product provided to end users, such as a specific software program or entertainment content item), IT resource (e.g., a specific computing component, such as a specific server rack), and so forth. In various embodiments, field values are vectorized in preparation for clustering. Vectorization refers to conversion of data in a non-numerical format (e.g., text) to a set of numerical values that can be mapped to a point in a vector space. Various vectorization approaches can be utilized. For example, a word vectorization technique such as continuous bag of words (CBOW), skip gram, or another technique that creates numerical representations of words can be utilized to generate numerical representations of text in alert fields.

In various embodiments, text in alert fields is tokenized before vectorization occurs. For example, a set of token words may be determined and extracted from a block of text by finding text separated by specified delimiters (e.g., blank spaces, punctuation, specific character sequences, etc.) that define boundaries of token words. Token words in a set of token words may also be normalized. Examples of normalization include converting any capitalized characters to lowercase, removing numbers, and removing other non-alphabetic characters. Normalization reduces the chance that semantically similar words are not determined to be the same due to minor formatting differences. Stemming may also be performed to convert inflected or derived words (e.g., grammatical variants) into their stem/base/root forms. For example, strings such as “transmitted”, “transmitting”, “transmitter”, “transmittal”, “transmits”, and so forth may be reduced to the stem “transmit”. Stemming may be performed according to a rules-based approach (e.g., by looking up word variants in a dictionary). Stemming may also be performed by applying a machine learning model trained to perform stemming. For example, a convolutional neural network may be trained on token words and their variants.

At 304, the plurality of alerts is divided into clusters based on the obtained parameters. In various embodiments, clustering is performed on the vector representations of the obtained parameters. Stated alternatively, in various embodiments, alerts are represented as numerical vectors that can be ingested by various clustering techniques. In some embodiments, density-based spatial clustering of applications with noise (DBSCAN) is utilized. Given a set of points in a space, DBSCAN locates points that are close according to a distance metric. The points in the space represent different alerts (e.g., points corresponding to feature vectors associated with the obtained parameters). Feature vectors can be regarded as sequences of parameters, wherein the sequences of parameters uniquely identify different alerts. In some embodiments, a Levenshtein distance is utilized to measure the distance between two alerts. Levenshtein distance is also referred to as an edit distance (e.g., edits required to convert one sequence into another). Other clustering approaches that can be used include K-means clustering, mean-shift clustering, expectation-minimization clustering using gaussian mixture models, agglomerative hierarchical clustering, and various other approaches known in the art.

In some embodiments, a trained machine learning model performs the clustering. The machine learning model can be utilized to determine similarity between alerts. Examples of machine learning models that can be utilized to perform clustering tasks include word vector representations, window-based neural networks, recurrent neural networks, long-short-term-memory models, recursive neural networks, and convolutional neural networks. Prior to utilizing the machine learning model, the machine learning model is trained on a collection of example alerts with known relatedness (e.g., known distance between the alerts). The training occurs before similarity of alerts is determined using the machine learning model in inference mode. Alerts that are related (e.g., within a specified distance of each other according to a distance metric) are clustered together.

In some embodiments, a centroid is calculated for each cluster that is determined. The centroid may be calculated as an average vector of the corresponding vector representations of alerts. The centroid vector itself does not necessarily correspond to a specific alert, but rather is a point in vector space around which vector representations of alerts can be clustered. It is also possible to employ different types of averages or different types of vector aggregation methods to calculate the centroid vector (e.g., by summing the vector representations of alerts, using machine learning to train a model to calculate the best centroid vector to represent a cluster of alerts, etc.).

At 306, a matching cluster for a new alert is determined. Stated alternatively, the new alert is compared to different clusters of alerts to determine a cluster from the different clusters to which the new alert is most similar. In some embodiments, the new alert is the alert received at 202 in FIG. 2. In some embodiments, the matching cluster is determined by determining the closest cluster to the new alert, including by computing vector distances between a vector representation of the new alert with different centroid vectors corresponding to the different clusters of alerts. In some embodiments, vector distances are computed according to the formula: d(v,c)=\sqrt{(v₁−c₁)²+(v₂−c₂)²+ . . . +(v_{N}−c_{N})²}, which is a Euclidean distance metric in which v is a vector to be compared to the centroid vector and c is the centroid vector. In this formula, both v and c have N vector components, and d is the determined distance between v and c. Various other vector comparison metrics (e.g., cosine similarity or another metric) can be utilized. The matching cluster can also be determined using various other comparison techniques known to those skilled in the art. Determining a matching cluster may also be performed by applying a trained machine learning model.

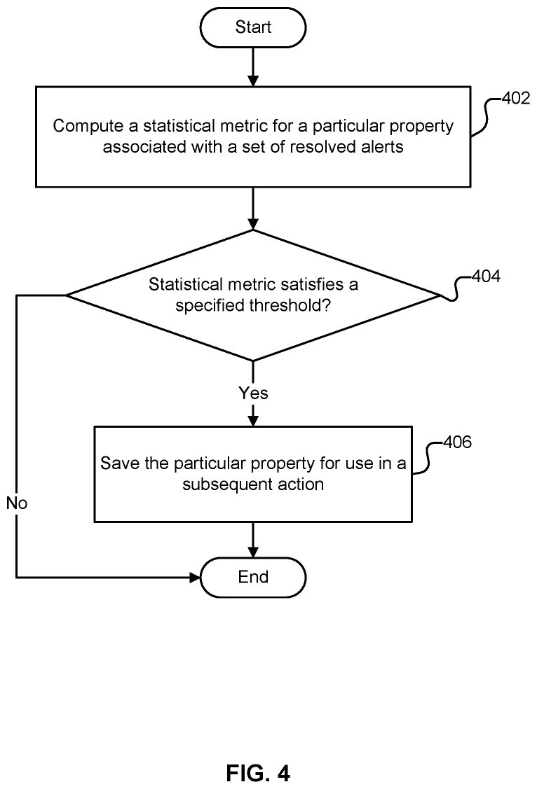

FIG. 4 is a flow diagram illustrating an embodiment of a process for identifying common properties of similar alerts. In some embodiments, the process of FIG. 4 is performed by IT management server 114 of FIG. 1. In some embodiments, at least a portion of the process of FIG. 4 is performed in 206 of FIG. 2.

At 402, a statistical metric is computed for a particular property associated with a set of resolved alerts. In some embodiments, the statistical metric is a prevalence metric, such as a percentage. For example, the percentage may be a percentage of alerts in the set of resolved alerts that share the particular property. In some embodiments, the particular property is whether an alert was elevated to incident status or another status that indicates a more severe IT problem. Thus, the statistical metric may be the percentage of alerts in the set of resolved alerts that were elevated to incident status or another status indicating a more severe problem.

At 404, it is determined whether the statistical metric satisfies a specified threshold. For example, with respect to the statistical metric being a percentage, the specified threshold may be 50%, 60%, 70%, or another percentage value. In various embodiments, the specified threshold is a value between 0-100 and can be configured by a user to adjust for whether more results that are less accurate (lower threshold) or fewer results that are more accurate (higher threshold) is desired. If at 404 it is determined that the statistical metric does not satisfy the specified threshold, then no further action is taken. If at 404 it is determined that the statistical metric satisfies the specified threshold, the process of FIG. 4 continues at 406.

At 406, the particular property is saved for use in a subsequent action. In some embodiments, the subsequent action is to cause the particular property to be inherited by a new alert different from the set of resolved alerts. For example, the new alert may have been determined to be similar to the set of resolved alerts and thus should inherit certain properties of alerts of the set of resolved alerts. In the case of the particular property being elevation to incident status, inheriting that particular property would correspond to predicting that the new alert will turn into an incident (or otherwise become a more severe IT problem) based on similar prior alerts doing the same.

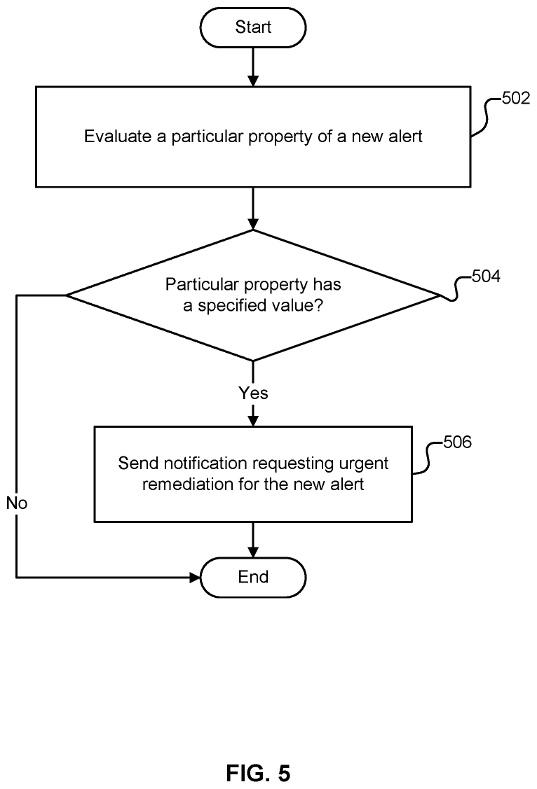

FIG. 5 is a flow diagram illustrating an embodiment of a process for taking an action based on an inherited alert property. In some embodiments, the process of FIG. 5 is performed by IT management server 114 of FIG. 1. In some embodiments, the process of FIG. 5 is performed in response to a new alert inheriting a common property among a set of resolved alerts.

At 502, a particular property of a new alert is evaluated. In some embodiments, the particular property is associated with whether the new alert is predicted to become an incident or otherwise predicted to become a more serious IT problem. In some embodiments, the new alert is the received new alert at 202 of FIG. 2.

At 504, it is determined whether the particular property has a specified value. For example, a property associated with incident and/or alert severity status may be evaluated to determine whether incident status prediction is “yes”, a priority level associated with alert severity reaches a “1” or other highest priority level, etc. If at 504 it is determined that the particular property does not have the specified value, then no further action is taken. If at 504 it is determined that the particular property has the specified value, the process of FIG. 5 continues at 506.

At 506, a notification requesting urgent remediation for the new alert is sent. In some embodiments, the notification is an email or other electronic notification. In some embodiments, the notification is sent to an IT specialist/technician. In various embodiments, urgent remediation (e.g., immediate on-site remediation) is requested because the particular property having the specified value indicates that significant loss (e.g., economic or other loss) would occur if remediation for the new alert did not begin as soon as possible. In some embodiments, a machine learning result explanation is provided. For example, the notification can indicate why the particular property has the specified value based on the one or more statistical metrics (e.g., a specified threshold percentage of similar prior alerts shared the particular property).

FIG. 6 is a functional diagram illustrating a programmed computer system. In some embodiments, the programmed computer system is included in client 102 and/or IT management server 114 of FIG. 1. In some embodiments, the programmed computer system is included in one or more IT assets of system 100 of FIG. 1.

In the example shown, computer system 600 includes various subsystems as described below. Computer system 600 includes at least one microprocessor subsystem (also referred to as a processor or a central processing unit (CPU)) 602. For example, processor 602 can be implemented by a single-chip processor or by multiple processors. In some embodiments, processor 602 is a general-purpose digital processor that controls the operation of computer system 600. Using instructions retrieved from memory 610, processor 602 controls the reception and manipulation of input data, and the output and display of data on output devices (e.g., display 618).

Processor 602 is coupled bi-directionally with memory 610, which can include a first primary storage, typically a random-access memory (RAM), and a second primary storage area, typically a read-only memory (ROM). As is well known in the art, primary storage can be used as a general storage area and as scratch-pad memory, and can also be used to store input data and processed data. Primary storage can also store programming instructions and data, in the form of data objects and text objects, in addition to other data and instructions for processes operating on processor 602. Also, as is well known in the art, primary storage typically includes basic operating instructions, program code, data, and objects used by processor 602 to perform its functions (e.g., programmed instructions). For example, memory 610 can include any suitable computer-readable storage media, described below, depending on whether, for example, data access needs to be bi-directional or uni-directional. For example, processor 602 can also directly and very rapidly retrieve and store frequently needed data in a cache memory (not shown).

Persistent memory 612 (e.g., a removable mass storage device) provides additional data storage capacity for computer system 600, and is coupled either bi-directionally (read/write) or uni-directionally (read only) to processor 602. For example, persistent memory 612 can also include computer-readable media such as magnetic tape, flash memory, PC-CARDS, portable mass storage devices, holographic storage devices, and other storage devices. A fixed mass storage 620 can also, for example, provide additional data storage capacity. The most common example of fixed mass storage 620 is a hard disk drive. Persistent memory 612 and fixed mass storage 620 generally store additional programming instructions, data, and the like that typically are not in active use by processor 602. It will be appreciated that the information retained within persistent memory 612 and fixed mass storages 620 can be incorporated, if needed, in standard fashion as part of memory 610 (e.g., RAM) as virtual memory.

In addition to providing processor 602 access to storage subsystems, bus 614 can also be used to provide access to other subsystems and devices. As shown, these can include a display monitor 618, a network interface 616, a keyboard 604, and a pointing device 606, as well as an auxiliary input/output device interface, a sound card, speakers, and other subsystems as needed. For example, pointing device 606 can be a mouse, stylus, track ball, or tablet, and is useful for interacting with a graphical user interface.

Network interface 616 allows processor 602 to be coupled to another computer, computer network, or telecommunications network using a network connection as shown. For example, through network interface 616, processor 602 can receive information (e.g., data objects or program instructions) from another network or output information to another network in the course of performing method/process steps. Information, often represented as a sequence of instructions to be executed on a processor, can be received from and outputted to another network. An interface card or similar device and appropriate software implemented by (e.g., executed/performed on) processor 602 can be used to connect computer system 600 to an external network and transfer data according to standard protocols. Processes can be executed on processor 602, or can be performed across a network such as the Internet, intranet networks, or local area networks, in conjunction with a remote processor that shares a portion of the processing. Additional mass storage devices (not shown) can also be connected to processor 602 through network interface 616.

An auxiliary I/O device interface (not shown) can be used in conjunction with computer system 600. The auxiliary I/O device interface can include general and customized interfaces that allow processor 602 to send and, more typically, receive data from other devices such as microphones, touch-sensitive displays, transducer card readers, tape readers, voice or handwriting recognizers, biometrics readers, cameras, portable mass storage devices, and other computers.

In addition, various embodiments disclosed herein further relate to computer storage products with a computer readable medium that includes program code for performing various computer-implemented operations. The computer-readable medium is any data storage device that can store data which can thereafter be read by a computer system. Examples of computer-readable media include, but are not limited to, all the media mentioned above: magnetic media such as hard disks, floppy disks, and magnetic tape; optical media such as CD-ROM disks; magneto-optical media such as optical disks; and specially configured hardware devices such as application-specific integrated circuits (ASICs), programmable logic devices (PLDs), and ROM and RAM devices. Examples of program code include both machine code, as produced, for example, by a compiler, or files containing higher level code (e.g., script) that can be executed using an interpreter.

The computer system shown in FIG. 6 is but an example of a computer system suitable for use with the various embodiments disclosed herein. Other computer systems suitable for such use can include additional or fewer subsystems. In addition, bus 614 is illustrative of any interconnection scheme serving to link the subsystems. Other computer architectures having different configurations of subsystems can also be utilized.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method, comprising:
receiving a new alert;
using machine learning to identify a plurality of resolved alerts similar to the new alert;
using one or more processors to automatically identify among properties of the identified similar resolved alerts, one or more common properties of the identified similar resolved alerts having one or more statistical metrics meeting one or more corresponding thresholds; and
causing the new alert to inherit the identified one or more common properties.

2. The method of claim 1, further comprising providing a machine learning result explanation based on the one or more statistical metrics.

3. The method of claim 1, wherein the new alert is associated with an information technology service or asset.

4. The method of claim 1, wherein using machine learning to identify the plurality of resolved alerts similar to the new alert includes selecting a cluster of resolved alerts from among a plurality of clusters of resolved alerts.

5. The method of claim 4, wherein the plurality of clusters of resolved alerts have been generated using a data clustering technique.

6. The method of claim 5, wherein the data clustering technique includes density-based spatial clustering of applications or K-means clustering.

7. The method of claim 4, wherein the plurality of clusters of resolved alerts have been generated based on properties of alerts stored in a database of alerts.

8. The method of claim 7, wherein the properties of the alerts stored in the database of alerts are associated with data fields of the alerts stored in the database of alerts.

9. The method of claim 4, wherein selecting the cluster of resolved alerts from among the plurality of clusters of resolved alerts includes identifying a cluster that is closest to the new alert according to a specified metric.

10. The method of claim 9, wherein the specified metric is associated with a vector distance metric.

11. The method of claim 9, wherein determining the cluster that is closest to the new alert includes determining centroid vectors for the clusters of the plurality of clusters of resolved alerts and comparing the determined centroid vectors with a vector representation of the new alert.

12. The method of claim 1, wherein the one or more common properties include an alert priority level.

13. The method of claim 1, wherein the one or more common properties include an increase over time in information technology problem severity.

14. The method of claim 1, wherein the one or more common properties are associated with alert data fields.

15. The method of claim 1, wherein the one or more statistical metrics include a metric indicating a prevalence of the one or more common properties among the identified similar resolved alerts.

16. The method of claim 1, wherein the one or more corresponding thresholds include a percentage threshold.

17. The method of claim 1, further comprising sending a notification to request remediation of the new alert.

18. The method of claim 17, wherein the notification includes an email notification.

19. A system, comprising:
one or more processors configured to:
receive a new alert;
use machine learning to identify a plurality of resolved alerts similar to the new alert;
automatically identify among properties of the identified similar resolved alerts, one or more common properties of the identified similar resolved alerts having one or more statistical metrics meeting one or more corresponding thresholds; and
cause the new alert to inherit the identified one or more common properties; and
a memory coupled to at least one of the one or more processors and configured to provide at least one of the one or more processors with instructions.

20. A computer program product embodied in a non-transitory computer readable medium and comprising computer instructions for:
receiving a new alert;
using machine learning to identify a plurality of resolved alerts similar to the new alert;
automatically identifying among properties of the identified similar resolved alerts, one or more common properties of the identified similar resolved alerts having one or more statistical metrics meeting one or more corresponding thresholds; and
causing the new alert to inherit the identified one or more common properties.
